(19) United States
(12) Patent Application Publication
(10) Pub. No.: US 2016/0290038 A1
(43) Pub. Date: Oct. 6, 2016

(54) BALANCED FOLDING/UNFOLDING DEVICE FOR A SHADE UNIT OF A WINDOW SHADE WITHOUT A PULL CORD

(71) Applicants: SHIH-MIN HUANG, (US); MING-HSUAN HSU, (US)

(72) Inventor: SHIH-MIN HUNG, CHANGHUA COUNTY (TW)

(21) Appl. No.: 14/676,001

(22) Filed: Apr. 1, 2015

(51) Int. Cl. E06B 9/322

(52) U.S. Cl. CPC E06B 9/322; E06B 2009/3222

(57) ABSTRACT

A balanced folding/unfolding device includes a top housing having a first string hole and a second string hole. A reverse winding portion and forward winding portion are mounted in the top housing. A vortex spring unit is mounted in the top housing and includes a first spring mechanism directly or indirectly connected to a first end of a first driving string and a first end of a second driving string. The first driving string and the second driving string extend in the same function. A second end of the first driving string extends around the forward winding portion and then passes downwards through the first cord hole for connection with a shade unit of a window shade without a pull cord. A second end of the second driving string extends around the reverse winding portion and then passes downwards through the second cord hole for connection with the shade unit.

### BACKGROUND OF THE INVENTION

The present invention relates to a folding/unfolding device for a window shade and, more particularly, to a balanced folding/unfolding device for a shade unit of a window shade without a pull cord.

Window shades can provide a shield from the sun and privacy as well as decoration in rooms and can even show the taste of the users. Modern window shades generally include a pull cord to provide convenient folding/unfolding of a shade unit. However, the exposed length of the pull cord may strangle a child playing nearby, which problem is highlighted in countries that value human rights and demand regulations for safe window shades.

Window shades without a pull cord have been developed and use a driving string to move the shade unit. Specifically, the window shades without a pull cord, though having differences in the main structure, generally includes a set of coiling springs (or known as vortex springs) connected to an end of a driving string. and the other end of the driving string is fixed to the shade unit of the window shade. The weight of the shade unit and the elasticity of the vortex springs are in a balanced state. The balanced state can be manually broken when it is desired to fold or unfold the shade unit. In actual use, a plurality of sets of vortex springs is used and is directly or indirectly connected to a plurality of driving strings, respectively. The driving strings are fixed to the shade unit. The elastic forces could come from different vortex springs and, thus, have difference factors. Furthermore, the forces transmitted to the shade unit could be uneven due to changes in the extending directions of the driving strings. The results are an oblique, shade unit and/or non-smooth folding/unfolding operation of the shade unit.

Thus, a need exists for a novel folding/unfolding device providing even forces transmitted to the driving strings for the shade unit to prevent the oblique state and/or non-smooth folding/unfolding operation of the shade unit.

### BRIEF SUMMARY OF THE INVENTION

A balanced folding/unfolding device for a shade unit of a window shade without a pull cord according to the present invention includes a top housing having a first string hole and a second string hole. A reverse winding portion and forward winding portion are mounted in the top housing. A vortex spring unit is mounted in the top housing and includes a first spring mechanism directly or indirectly connected to a first end of a first driving string and a first end of a second driving string. The first driving string and the second driving string extend in the same function. A second end of the first driving string extends around the forward winding portion and then passes downwards through the first cord hole for connection with a shade unit of a window shade without a pull cord. A second end of the second driving string extends around the reverse winding portion and then passes downwards through the second cord hole for connection with the shade unit.

The reverse winding portion can be a guiding column or a guiding wheel. The forward winding portion can be a guiding column or a guiding wheel. The reverse winding portion and the forward winding portion are mounted in a frame. The frame includes a rod extending across the reverse winding portion and the forward winding portion. The first driving string extends around the rod and then extends around the forward winding portion. The second driving string extends around the rod and then extends around the reverse winding portion.

The balanced folding/unfolding device can further include a driving string distributor and a distal string portion. The driving string distributor includes a frame. The reverse winding portion is mounted in aside of the frame adjacent to the vortex spring unit. The forward winding portion is mounted in the other side of the frame distant to the vortex spring unit. The first string hole is located in a bottom of the driving string distributor. The second string hole is located in a bottom of the distal string portion. The first spring mechanism can include a first vortex spring and first, second, and third wheels. One of the first and second wheels coils the first vortex spring while the other of the first and second wheels uncoils the first vortex spring. The first driving string and the second driving string are wound around the third wheel. A gear is mounted to each of the second and third wheels. The gears on the second and third wheels mesh with each other.

The vortex spring unit can further include a second spring mechanism having a second vortex spring and fourth and fifth wheels. One of the fourth and fifth wheels coils the second vortex spring while the other of the fourth and fifth wheels uncoils the second vortex spring. A gear is mounted to each of the first and fifth wheels. The gears on the first and fifth wheels mesh with each other.

The driving string distributor can include two guiding wheels spaced from each other by a gap, and the gap forms the first string hole.

The distal string portion can include two guiding wheels spaced from each other by a gap, and the gap forms the second string hole. Each of the driving string distributor and the distal string portion can include an upright column. The upright column of the driving string distributor guides the first driving string into the first string hole. The upright column of distal string portion guides the second driving string into the second string hole.

The vortex spring unit can be mounted between the driving string distributor and the distal string portion.

The present invention will become clearer in light of the following detailed description of illustrative embodiments of this invention described in connection with the drawings.

### DESCRIPTION OF THE DRAWINGS

FIG. 1 is a perspective view of a window shade including a balanced folding/unfolding device for a shade unit of a second embodiment according to the present invention.

FIG. 2 is a partial, perspective view of the window shade of the second embodiment according to the present invention.

FIG. 3 is an exploded, perspective view of the window shade of the second embodiment according to the present invention, illustrating an angular position adjusting mechanism for the shade unit.

FIG. 4 is a perspective view illustrating first and second driving strings of the second embodiment, with a top housing of the balanced folding/unfolding device removed for clarity.

FIG. 5 is a top view of the balanced folding/unfolding device according to the present invention, with the top housing removed for clarity.

FIG. 6 is a perspective view illustrating another example of disposition of a vortex spring unit of the balanced folding/unfolding device of the second embodiment.

FIG. 7 is a top view of a balanced folding/unfolding device of a first embodiment according to the present invention, with atop housing removed for clarity.

FIG. 8 is a perspective view of a portion of the first embodiment according to the present invention.

### DETAILED DESCRIPTION OF THE INVENTION

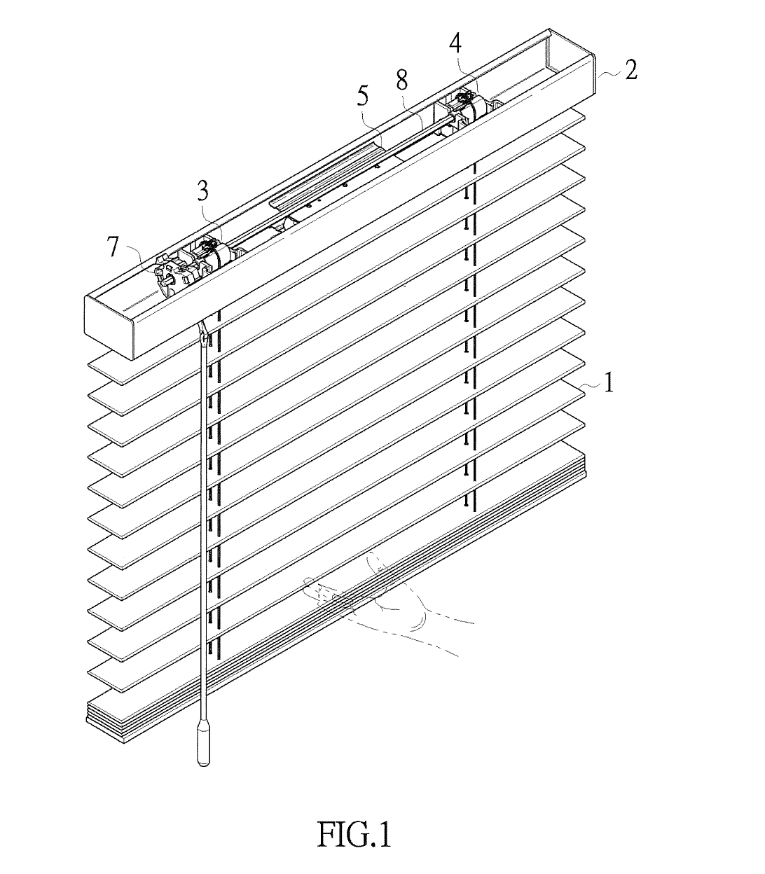

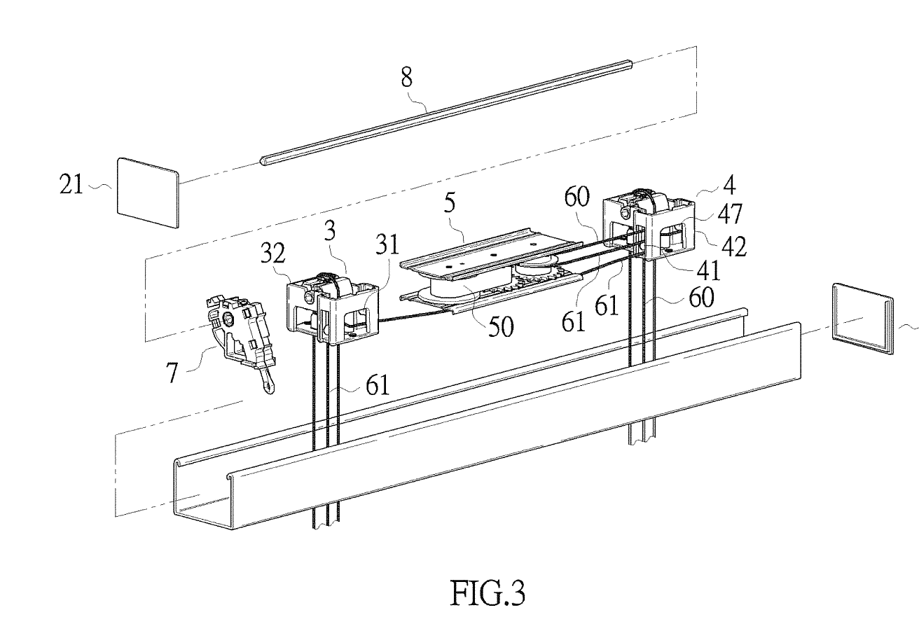

FIG. 1 is a perspective view of a window shade without a pull cord and including a balanced folding/unfolding device for a shade unit 1 according to the present invention. In the form shown, the shade unit 1 includes a plurality of slats and can be used together with an angular position adjusting member 7 and a hexagonal rod 8 (see FIG. 3) to be driven by the angular position adjusting member 7 to thereby adjust a tilt angle of the slats. When it is desired to fold the shade unit 1, a user can apply a force to break the balance.

The balanced folding/unfolding device according to the present invention includes a top housing 2 having a first string hole 40 and a second string hole 30. The top housing 2 includes two side boards 21 and 22 for closing two ends thereof.

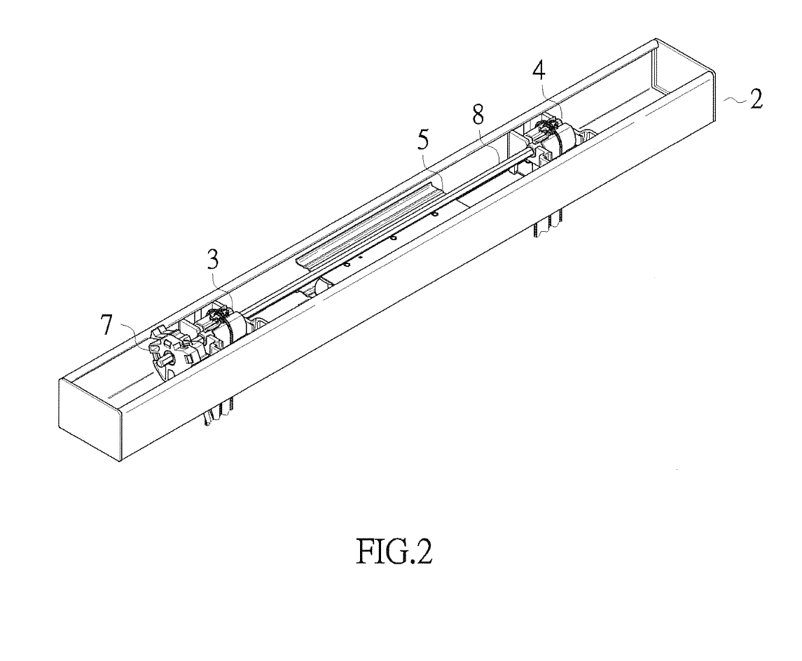

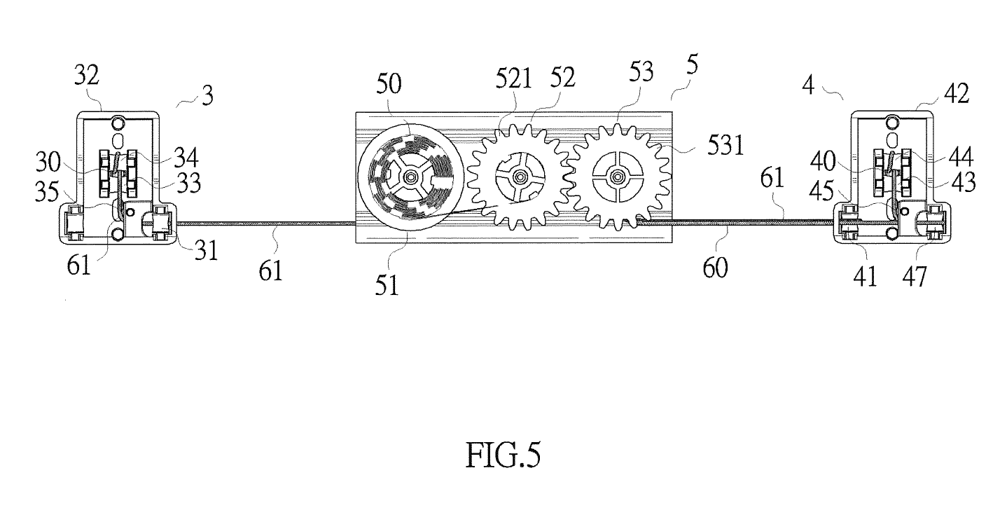

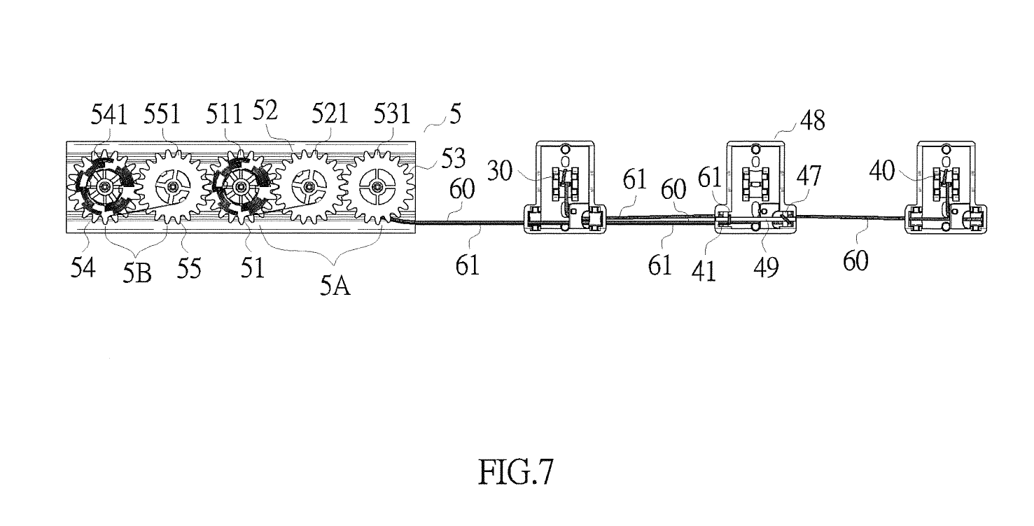

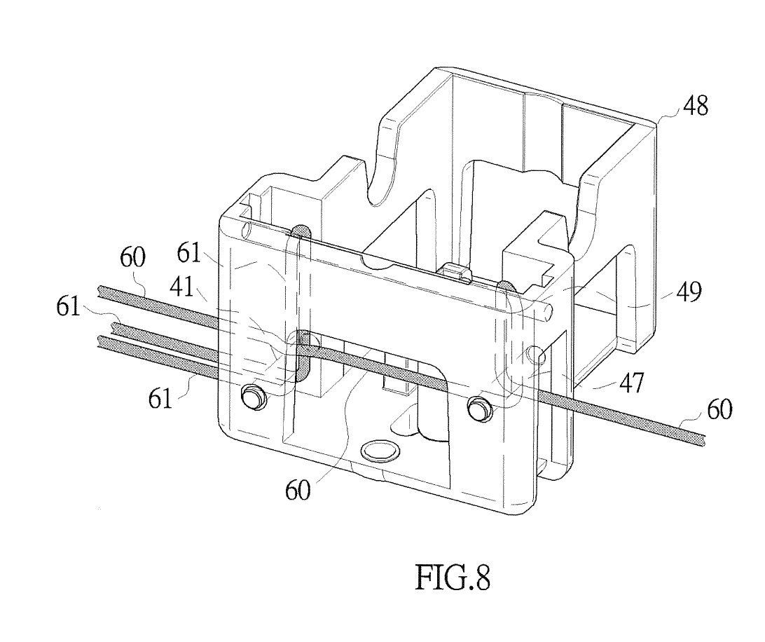

FIGS. 7 and 8 show a first embodiment of the balanced folding/unfolding device, wherein the top housing 2 is removed for clarity, but the first and second string holes 40 and 30 are not removed. FIGS. 1-6 show a second embodiment of the balanced folding/unfolding device.

The balanced folding/unfolding device further includes a reverse winding portion 41 mounted in the top housing 2, a forward winding portion 47 mounted in the top housing 2, and a vortex spring unit 5 mounted in the top housing 2. The vortex spring unit 5 includes a first spring mechanism 5A directly or indirectly connected to a first end of a first driving string 60 and a first end of a second driving string 61. The first driving string 60 and the second driving string 61 extend in the same function. A second end of the first driving string 60 extends around the forward winding portion 47 to change the extending direction and then passes downwards through the first cord hole 40 for connection with the shade unit 1. A second end of the second driving string 60 extends around the reverse winding portion 41 to reverse the extending direction and then passes downwards through the second cord hole 30 for connection with the shade unit 1.

The first spring mechanism 5A is the source of the elastic force for both of the first driving string 60 and the second driving string 61. Furthermore, the second end of the first driving string 60 and the second end of the second driving string 61 are both guided towards the reverse winding portion 41. As mentioned above, the second end of the first driving string 60 extends around the forward winding portion 47 to change the extending direction and then passes downwards through the first cord hole 40 for connection with the shade unit L The second end of the second driving string 60 extends around the reverse winding portion 41 to reverse the extending direction and then passes downwards through the second cord hole 30 for connection with the shade unit 1. Although the first driving string 60 and the second driving string 61 are spaced from each other, the guiding procedures for both of the first driving string 60 and the second driving string 61 are almost the same, such that the pull forces applied by the first driving string 60 and the second driving string 61 are evenly imparted to the shade unit 1 due to the same elastic force source and the substantially identical paths towards the reverse winding portion 41 and the forward winding portion 47. Thus, the driving forces transmitted to the shade unit 1 are even, reducing the risk of the oblique and/or non-smooth folding/unfolding operation of the shade unit 1. The reverse winding portion 41 can be a guiding column or a guiding wheel to reduce friction. Likewise, the forward winding portion 47 can be a guiding column or a guiding wheel to reduce friction. The reverse winding portion 41 and the forward winding portion 47 are mounted in a frame 48. The frame 48 includes a rod 49 extending across the reverse winding portion 41 and the forward winding portion 47. The first driving string 60 extends around the rod 49 and then extends around the forward winding portion 47. The second driving string 61 extends around the rod 49 and then extends around the reverse winding portion 41. The rod 49 provides correction or modification for the first driving string 60 and the second driving string 61 before the winding procedures to obtain substantially synchronous winding states before winding around the forward winding portion 47 and the reverse winding portion 41.

With reference to FIGS. 1 and 3-5, in the second embodiment, the balanced folding/unfolding device further includes a driving string distributor 4 and a distal string portion 3. The driving string distributor 4 includes a frame 42 for receiving the parts of the driving string distributor 4, permitting the whole driving string distributor 4 to be installed in the top housing 2 by screwing or embedding. In this embodiment, the reverse winding portion 41 is mounted in a side of the frame 42 adjacent to the vortex spring unit 5, and the forward winding portion 47 is mounted in the other side of the frame 42 distant to the vortex spring unit 5. The distal string portion 3 includes a frame 32 installed in the top housing 2. The distal string portion 3 further includes an inlet guiding wheel 31 permitting passage of the second driving string 61 from a side thereof. In a case that the second driving string 61 contacts the inlet guiding wheel 31, the second driving string 61 can pass the inlet guiding wheel 31 smoothly. The first string hole 41 is located in a bottom of the driving string distributor 4. The second string hole 30 is located in a bottom of the distal string portion 3. Thus, the assemblage positions of the parts are more reliable.

In the first and second embodiments, the first spring mechanism 5A includes a first vortex spring 50 and first, second, and third wheels 51, 52, and 53. One of the first and second wheels 51 and 52 coils the first vortex spring 50 while the other of the first and second wheels 51 and 52 uncoils the first vortex spring 50. The first driving string 60 and the second driving string 61 are wound around the third wheel 53. A gear 521, 531 is mounted to each of the second and third wheels 52 and 53. The gears 521 and 531 on the second and third wheels 52 and 53 mesh with each other.

In the first embodiment shown in FIG. 7, the vortex spring unit 5 further includes a second spring mechanism 5B. The second spring mechanism 5B includes a second vortex spring 50 and fourth and fifth wheels 54 and 535. One of the fourth and fifth wheels 54 and 55 coils the second vortex spring 50 while the other of the fourth and fifth wheels 54 and 55 uncoils the second vortex spring 5B. A gear 511, 551 is mounted to each of the first and fifth wheels 51 and 55. The gears 511 and 551 on the first and fifth wheels 51 and 55 mesh with each other. A gear 541 is mounted on the fourth wheel 54 and meshes with the gear 551 on the fifth wheel 55. It can be appreciated that the second spring mechanism 5B can be used in the second embodiment if desired. Under the meshing and joint rotation of the gears, the first and second spring mechanisms 5A and 5B still provide the same elastic force source for use in a case of a heavy shade unit 1 to increase the elastic force.

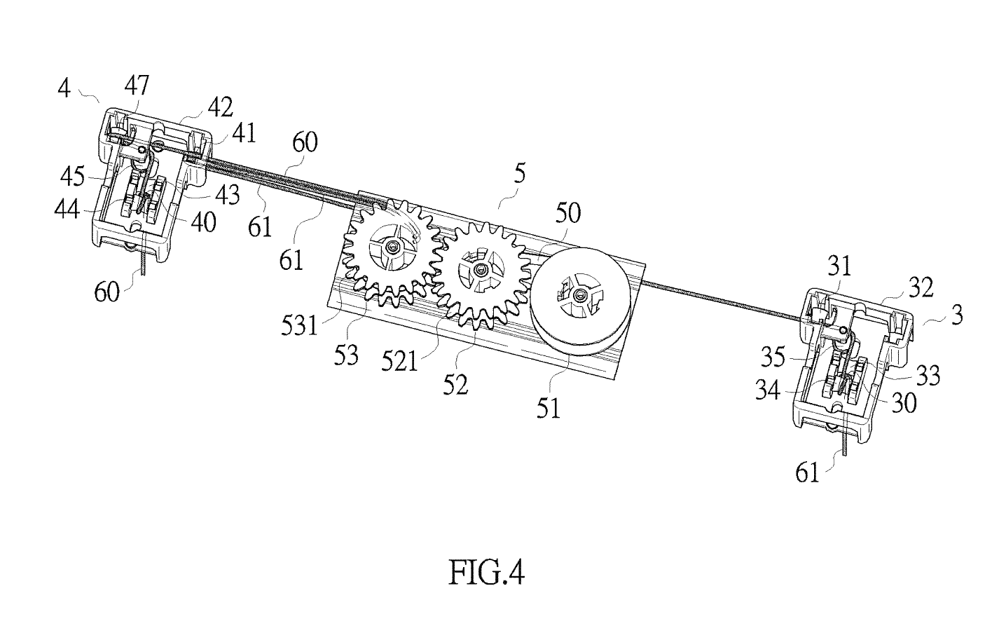

With reference to FIG. 4, in the second embodiment, the driving string distributor 4 includes two guiding wheels 43 and 44 spaced from each other by a gap.

The gap forms the first string hole 40 to permit smooth passage of the first driving string 60. Likewise, the distal string portion 3 includes two guiding wheels 33 and 34 spaced from each other by a gap, and the gap forms the second string hole 30 to permit smooth passage of the second driving string 61. With reference to FIG. 4, in the second embodiment, each of the driving string distributor 4 and the distal string portion 3 includes an upright column 35, 45. The upright column 45 of the driving string distributor 4 guides the first driving string 60 into the first string hole 40, and the upright column 35 of distal string portion 3 guides the second driving string 61 into the second string hole 30, avoiding non-smooth movement due to the angular positions of the first driving string 60 and the second driving string 61.

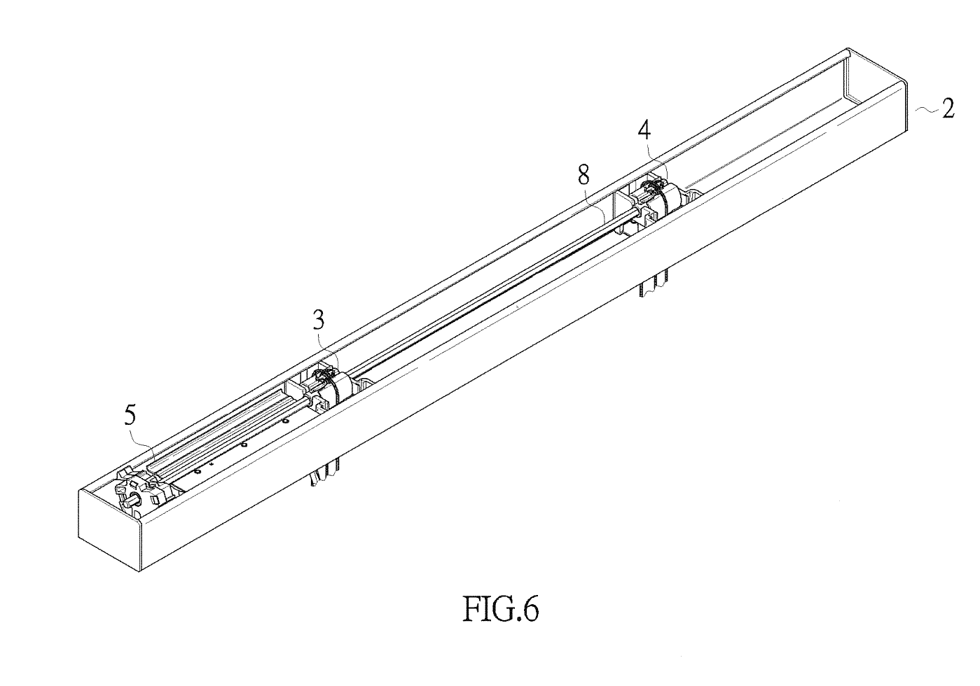

With reference to FIG. 4, in the second embodiment, the vortex spring unit 5 is mounted between the driving string distributor 4 and the distal string portion 3, such that the turning points of the first driving string 60 and the second driving string 61 are close to each other to reduce the friction parameter before turning. In another example shown in FIG. 6, the vortex spring unit 5 can be mounted in the top housing 2, and the distal string portion 3 is located between the vortex spring unit 5 and the driving string distributor 4. The vortex spring unit 5 in this position permits easy detachment for maintenance or replacement. The position of the vortex spring unit 5 can be varied in consideration of smooth passage of the first driving string 60 and the second driving string 61 through the first and second string holes 40 and 30.

Although specific embodiments have been illustrated and described, numerous modifications and variations are still possible without departing from the scope of the invention. The scope of the invention is limited by the accompanying claims.

1. A balanced folding/unfolding device for a shade unit of a window shade without a pull cord, comprising:
a top housing including a first string hole and a second string hole;
a reverse winding portion mounted in the top housing;
a forward winding portion mounted in the top housing;
a vortex spring unit mounted in the top housing, with the vortex spring unit including a first spring mechanism directly or indirectly connected to a first end of a first driving string and a first end of a second driving string, with the first driving string and the second driving string extending in a same function, with a second end of the first driving string extending around the forward winding portion and then passing downwards through the first cord hole for connection with a shade unit of a window shade without a pull cord, with a second end of the second driving string extending around the reverse winding portion and then passing downwards through the second cord hole for connection with the shade unit.

2. The balanced folding/unfolding device for a shade unit of a window shade without a pull cord as claimed in claim 1, with the reverse winding portion being a guiding column or a guiding wheel, with the forward winding portion being a guiding column or a guiding wheel, with the reverse winding portion and the forward winding portion mounted in a frame, with the frame including a rod extending across the reverse winding portion and the forward winding portion, with the first driving string extending around the rod and then extending around the forward winding portion, and with the second driving string extending around the rod and then extending around the reverse winding portion.

3. The balanced folding/unfolding device for a shade unit of a window shade without a pull cord as claimed in claim 1, further comprising a driving string distributor and a distal string portion, with the driving string distributor including a frame, with the reverse winding portion mounted in a side of the frame adjacent to the vortex spring unit, with the forward winding portion mounted in another side of the frame distant to the vortex spring unit, with the first string hole located in a bottom of the driving string distributor, and with the second string hole located in a bottom of the distal string portion.

4. The balanced folding/unfolding device for a shade unit of a window shade without a pull cord as claimed in claim 2, with the first spring mechanism including a first vortex spring and first, second, and third wheels, with one of the first and second wheels coiling the first vortex spring while another of the first and second wheels uncoiling the first vortex spring, with the first driving string and the second driving string wound around the third wheel, with a gear mounted to each of the second and third wheels, with the gears on the second and third wheels meshed with each other.

5. The balanced folding/unfolding device for a shade unit of a window shade without a pull cord as claimed in claim 4, with the vortex spring unit further including a second spring mechanism, with the second spring mechanism including a second vortex spring and fourth and fifth wheels, with one of the fourth and fifth wheels coiling the second vortex spring while another of the fourth and fifth wheels uncoiling the second vortex spring, with a gear mounted to each of the first and fifth wheels, with the gears on the first and fifth wheels meshed with each other.

6. The balanced folding/unfolding device for a shade unit of a window shade without a pull cord as claimed in claim 3, with the driving string distributor including two guiding wheels spaced from each other by a gap, and with the gap forming the first string hole.

7. The balanced folding/unfolding device for a shade unit of a window shade without a pull cord as claimed in claim 3, with the distal string portion including two guiding wheels spaced from each other by a gap, and with the gap forming the second string hole.

8. The balanced folding/unfolding device for a shade unit of a window shade without a pull cord as claimed in claim 3, with each of the driving string distributor and the distal string portion including an upright column, with the upright column of the driving string distributor guiding the first driving string into the first string hole, and with the upright column of distal string portion guiding the second driving string into the second string hole.

9. The balanced folding/unfolding device for a shade unit of a window shade without a pull cord as claimed in claim 3, with the vortex spring unit mounted between the driving string distributor and the distal string portion.
